(19) United States
(12) Patent Application Publication
(10) Pub. No.: US 2026/0169115 A1
(43) Pub. Date: Jun. 18, 2026

(54) MULTI-SENSOR PULSE CLUSTERING

(71) Applicant: BAE Systems Information and Electronic Systems Integration Inc., Nashua, NH (US)

(72) Inventor: Brian K. Decker, Amherst, NH (US)

(73) Assignee: BAE Systems Information and Electronic Systems Integration Inc., Nashua, NH (US)

(21) Appl. No.: 18/983,679

(22) Filed: Dec. 17, 2024

(51) Int. Cl. G01S 3/46; G01S 7/02

(52) U.S. Cl. CPC G01S 3/46; G01S 7/021

(57) ABSTRACT

Techniques are provided for multi-sensor pulse clustering. A system implementing the techniques according to an embodiment includes a pulse direction calculator configured to calculate a direction of arrival of a pulse received through an antenna array. The direction of arrival calculation is based on pulse phase measurement differences between elements of the antenna array. The system also includes a rotation transformer configured to align the direction of arrival to platform body or navigational coordinates. The system further includes a pilot vector comparator configured to match the aligned direction of arrival to one or more pilot vectors, the pilot vectors indicating directions of interest. In some embodiments, the pilot vectors are obtained from an emitter tracking system or from an operator of the platform. In some embodiments, the pilot vectors are based on an intersection of directions of arrival obtained from multiple antenna arrays.

### STATEMENT OF GOVERNMENT INTEREST

This invention was made with United States Government assistance under Contract No. N00019-19-C-0010. The United States Government has certain rights in this invention.

### FIELD OF DISCLOSURE

The present disclosure relates to radio frequency (RF) signal detection, and more particularly to pilot vector based multi-sensor pulse clustering.

### BACKGROUND

Military aircraft sometimes operate in dense threat environments. Airborne passive electronic warfare systems aboard such aircraft receive and process radar pulses that originate from multiple emitter sources. The ability to correlate received pulses with associated emitters is important for identifying and tracking threats.

### BRIEF DESCRIPTION OF THE DRAWINGS

FIG. 1 illustrates a platform configured for multi-sensor pulse clustering in a threat environment, in accordance with certain embodiments of the present disclosure.

FIG. 2 is a more detailed view of the platform configured for multi-sensor pulse clustering, in accordance with certain embodiments of the present disclosure.

FIG. 3 is a block diagram of the multi-sensor pulse clustering system of FIG. 2, configured in accordance with certain embodiments of the present disclosure.

FIG. 4 is a block diagram of the clustering processor of FIG. 3, configured in accordance with certain embodiments of the present disclosure.

FIG. 5 illustrates conic angle direction of arrival and pilot vectors, in accordance with certain embodiments of the present disclosure.

FIG. 6 is a flowchart illustrating a methodology for multi-sensor pulse clustering, in accordance with an embodiment of the present disclosure.

FIG. 7 is a block diagram of a processing platform configured to perform multi-sensor pulse clustering, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for multi-sensor pulse clustering using pilot vectors to guide the sorting of pulses into groups of pulses that are transmitted from the same emitter. As noted above, airborne electronic warfare systems receive and process radar pulses that originate from multiple emitter sources. The ability to group received pulses into clusters that are associated with emitters is important for identifying and tracking threats. Direction of arrival is one sorting criterion that can be used to group received pulses into clusters associated with emitters. Sorting pulses based on direction of arrival is challenging, however, due to a number of factors including platform body motion during a collection time frame, sensor ambiguity (e.g., short baseline interferometry), and the use of multiple measurement configurations that may employ different sensors.

To this end, and in accordance with an embodiment of the present disclosure, techniques are provided for multi-sensor pulse clustering to sort received pulses into clusters associated with different emitters. The sensors are antenna arrays which may be located on different platform control surfaces such as leading edge wing flaps and/or aft wing surfaces. The disclosed techniques utilize pilot vectors to guide the pulse sorting based on direction of arrival. In some embodiments, the pulse cluster processing may be performed at the receiver level (e.g., in receiver firmware) and/or by a preprocessing module that operates between the receiver and other higher level processing applications.

In accordance with an embodiment, a system implementing the techniques for multi-sensor pulse clustering includes a pulse direction calculator configured to calculate a direction of arrival of a pulse received through an antenna array. The direction of arrival calculation is based on pulse phase measurement differences between elements of the antenna array. The system also includes a rotation transformer configured to align the calculated direction of arrival to platform body coordinates. The system further includes a pilot vector comparator configured to match the aligned direction of arrival to one or more pilot vectors which indicate directions of interest. In some embodiments, the pilot vectors are obtained from an emitter tracking system or from an operator of the platform. In some embodiments, the pilot vectors are based on an intersection of directions of arrival obtained from multiple antenna arrays. The system further includes a sorting circuit configured to sort the pulse into a buffer associated with the matched pilot vector.

It will be appreciated that the techniques described herein may provide improved electronic warfare operational performance compared to other systems that pass on all received pulses to higher level applications, such as trackers, which increases the computational burden on those applications to determine which pulses come from each tracked emitter. Numerous embodiments and applications will be apparent in light of this disclosure.

### System Architecture

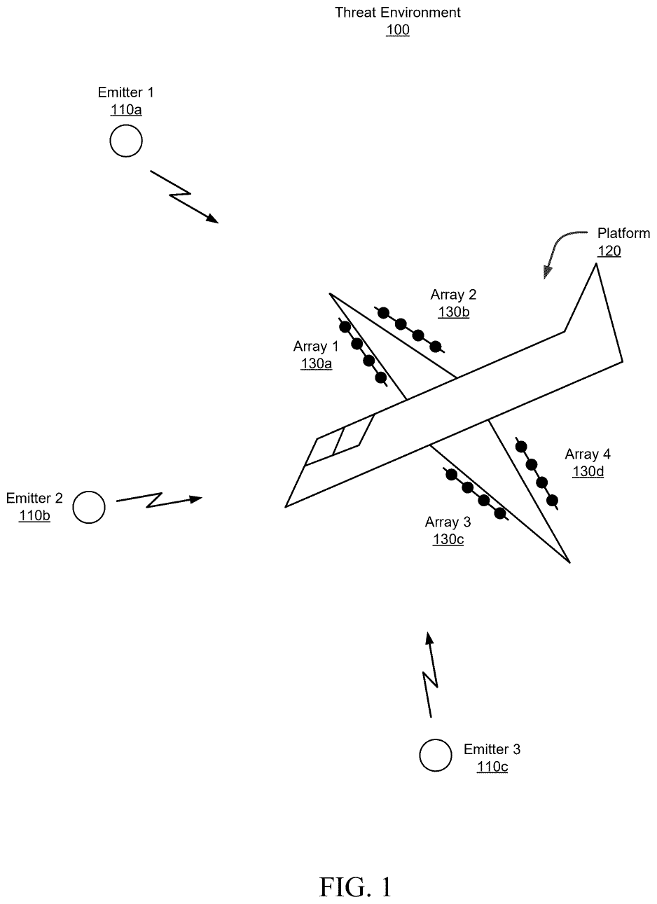

FIG. 1 illustrates a platform 120 configured for multi-sensor pulse clustering in a threat environment 100, in accordance with certain embodiments of the present disclosure. In some embodiments, the platform 120 may be an aircraft such as a fixed wing plane, a helicopter, or the like. In some embodiments, the platform 120 may be an unmanned airborne platform such as a drone, missile, or the like. The platform 120 is shown to include any number of sensors which are implemented as antenna arrays 130a, . . . 130d, etc. The antenna arrays may also be referred to as apertures. The antenna arrays comprise multiple antenna elements, for example four elements as illustrated in this example, although any number of elements may be employed. In some embodiments, the arrays are linear arrays (e.g., 1-dimensional arrays), as shown in this example. In some embodiments, the arrays are planar arrays (e.g., 2-dimensional arrays). Other array configurations including 3-dimensional arrays are also possible. The arrays may be deployed on any suitable surface of the platform such as, for example, the fore and aft regions of the wings, as shown in this illustration.

The threat environment 100 may include any number of emitters 110a, 110b, 110c, etc., that transmit RF pulses which are received by the platform 120. The pulses are received through the antenna arrays 130. The emitters 110 may be associated with threats that are attempting to detect, identify, and track the platform 120.

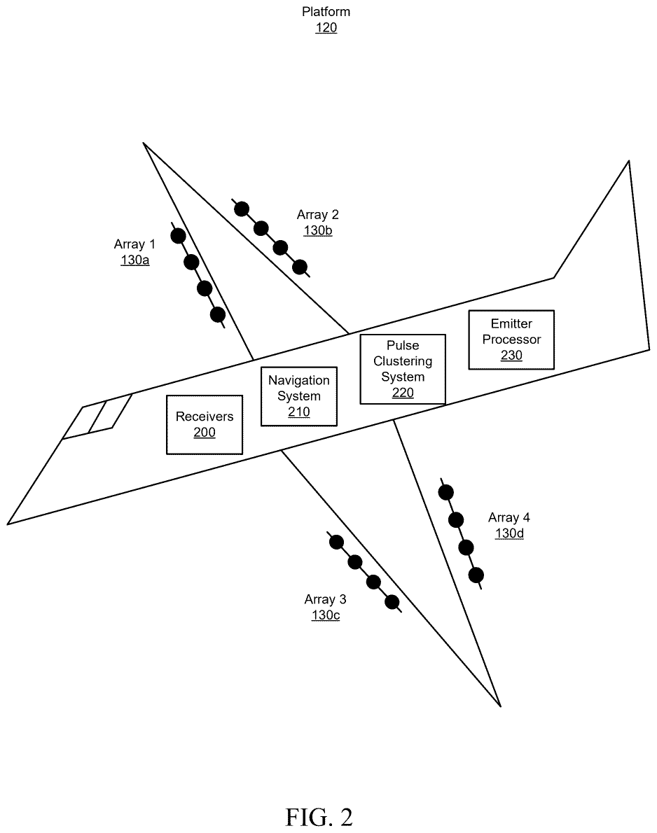

FIG. 2 is a more detailed view of the platform 120, configured for multi-sensor pulse clustering, in accordance with certain embodiments of the present disclosure. The platform is shown to include receivers 200, navigation system 210, pulse clustering system 220, and emitter processor 230.

Receivers 200 are coupled to the antenna arrays 130 and configured to receive RF signals including pulses transmitted by the emitters. The receivers may also measure phase differences between the pulses received at each antenna element for use by the pulse clustering system 220, as described below. The receivers may also measure other pulse characteristics that can be stored, for example in a pulse descriptor word to be associated with the pulse, for use by downstream applications that operate on the sorted pulses.

Navigation system 210 is configured to provide data on the position and orientation of the platform, including yaw, pitch, and roll, for use by the pulse clustering system 220.

Operation of the pulse clustering system 220 will be described in greater detail below, but at a high level, the clustering system 220 is configured to sort received pulses into clusters associated with different emitters based on direction of arrival, platform navigation data, and target tracking feedback in the form of pilot vectors which indicate directions of interest. For example, pilot vectors may be unit vectors that represent a line of sight hypothesis.

Emitter processor 230 includes any suitable higher level application processing that may be performed on the sorted pulses. Examples include identification, tracking, and targeting of the emitters associated with the sorted pulses.

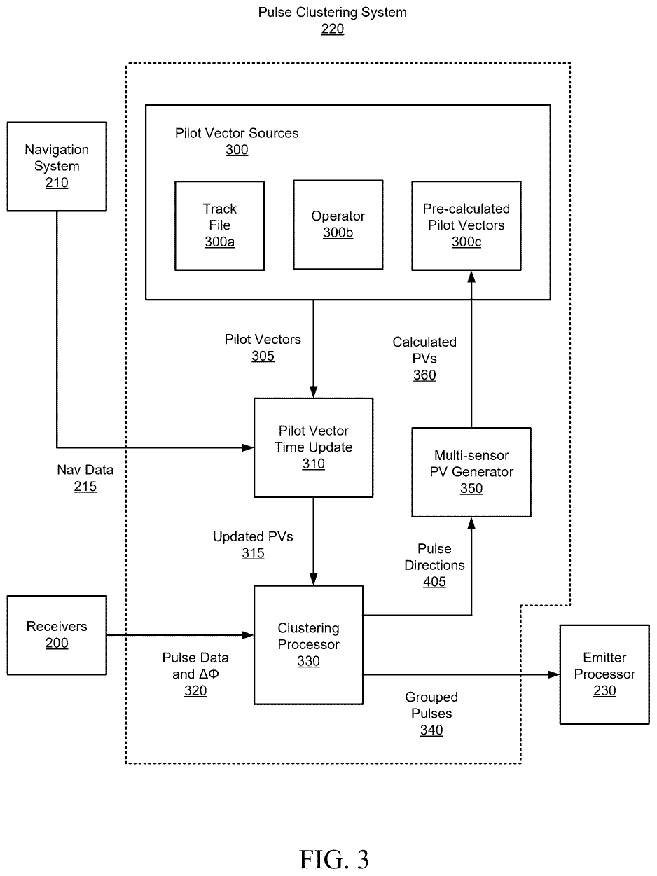

FIG. 3 is a block diagram of the multi-sensor pulse clustering system 220 of FIG. 2, configured in accordance with certain embodiments of the present disclosure. The multi-sensor pulse clustering system 220 is shown to include pilot vector sources 300, pilot vector time update circuit 310, clustering processor 330, and multi-sensor pilot vector generator 350.

Pilot vector sources 300 are configured to provide pilot vectors 305 which are unit vectors that indicate a direction to potential emitters of interest. For example, in some embodiments, the pilot vectors 305 are obtained from a track file 300a which may be generated by an emitter tracking system that is tracking current threats. In some embodiments, the pilot vectors 305 are obtained from an operator 300b of the platform (e.g., the pilot of the aircraft). For example, the operator may be aware of certain threats existing at known or estimated locations. In some embodiments, the pilot vectors 305 are pre-calculated vectors 300c, based on multi-sensor measurements obtained during processing of previous pulses. The pre-calculated pilot vectors 300c are generated by a multi-sensor pilot vector generator 350, as will be described below.

In some embodiments, the different sources of pilot vectors may be prioritized for use. For example, pilot vectors 300a obtained from a track file may be given highest priority while operator provided pilot vectors 300b may be given somewhat lower priority. In some embodiments, pre-calculated pilot vectors 300c may be given the lowest priority and used only when other sources (e.g., 300a and 300b) are not available.

Pilot vector time update circuit 310 is configured to perform a rotational coordinate transformation to update the pilot vectors 305 to a current time of flight based on navigation data 215 provided by the navigation system 210 of the platform. Because the pilot vectors may have last been updated many seconds in the past (for example by the tracker), they need to be extrapolated to the current time at which the pulse is received (also referred to as time of flight), so that they can be compared to the pulse direction of arrival in a common updated reference frame.

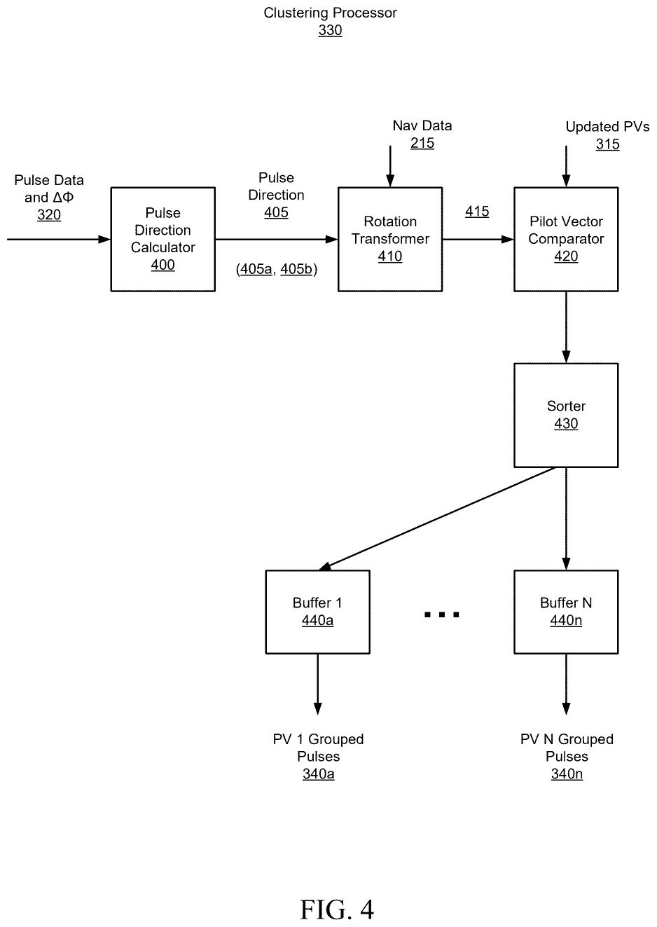

The clustering processor 330 is configured to perform clustering of pulses received from antenna arrays into emitter groupings and the multi-sensor pilot vector generator 350 is configured to generate pilot vectors for use on subsequently received pulses based on the current pulse. Operation of the clustering processor 330 and the multi-sensor pilot vector generator 350 is described in greater detail below in connection with FIG. 4.

FIG. 4 is a block diagram of the clustering processor 330 of FIG. 3, configured in accordance with certain embodiments of the present disclosure. Clustering processor 330 is shown to include pulse direction calculator 400, rotation transformer 410, pilot vector comparator 420, sorting circuit 430, and buffers 440.

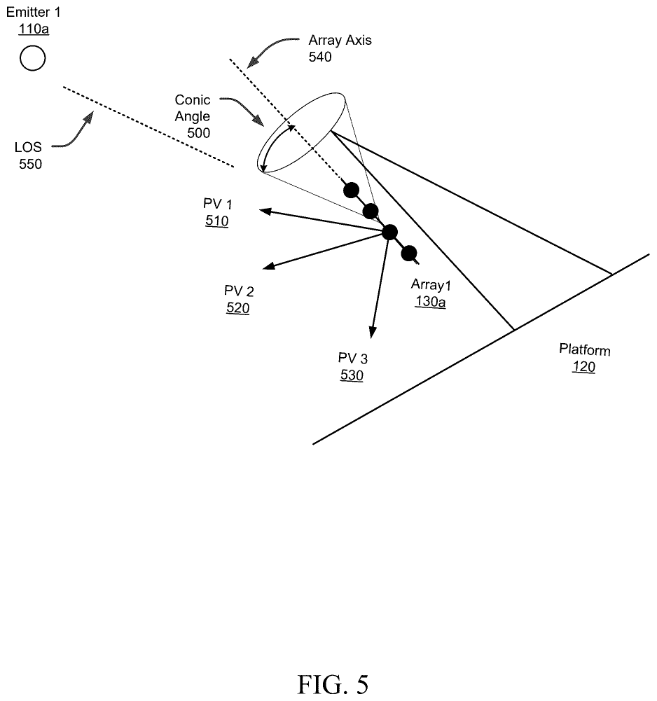

Pulse direction calculator 400 is configured to calculate a direction of arrival 405 of a pulse received through an antenna array. The direction of arrival calculation is based on pulse phase measurement differences 320 between elements of the antenna array, for example using short baseline interferometry. In some embodiments, the antenna array is a linear array, and the direction of arrival is a conic angle 500 between an axis of the linear array 540 and an array generated line of sight 550 to an emitter of the pulse (e.g., 110a), as illustrated in FIG. 5. The array generated line of sight 550 is subject to measurement error and other forms of error and may therefore not point directly at the emitter. In some other embodiments, the antenna array is a planar array or a 3-dimensional array, and the measured direction of arrival may be less ambiguous than a conic angle. For example, rather than a cone of ambiguity, the measured directional of arrival may be a relatively narrower beam, although still subject to error.

Rotation transformer 410 is configured to align the direction of arrival 405 to platform body coordinates (e.g., navigational coordinates) based on the navigation data 215 provided by the navigation system 210. Additionally, in some embodiments, for example where the linear antenna array is located on movable flaps of the wing or other platform control surfaces, sensors may be configured to provide further position and orientation corrections based on the motion/position of the control surfaces. These alignments and corrections may be accomplished using any suitable geometric coordinate transformation techniques.

In some embodiments, the pilot vectors are provided in Earth coordinates (e.g., latitude and longitude) and the rotation transformer is configured to further transform the aligned direction of arrival to Earth coordinates so that they can be compared to the pilot vectors in a common frame of reference.

Pilot vector comparator 420 is configured to match the aligned direction of arrival 415 to one or more of the time updated pilot vectors 315 indicating directions of interest. Referring to FIG. 5, for example, the conic angle 500 results in a measured line of sight 550 that can lie anywhere along the cone. The measured line of sight 500 can be compared to the available pilot vectors 510, 520, 530 to find a match to the closest pilot vector, which in this example is the first pilot vector 510. In some embodiments, a matrix inner product operation may be performed between each pilot vector and the array axis vector (pointing in the direction of the array axis 540) to generate an angle for each pilot vector against which the measured line of sight 550 can be compared to find the closest matching pilot vector.

Sorting circuit 430 is configured to sort the pulse into a buffer 440 associated with the matched pilot vector. Continuing with the example illustrated in FIG. 5, the pulse would be sorted into buffer 1 440a which is configured to store and group pulses 340a associated with pilot vector 1.

Buffers 440 are configured to store the sorted pulses 340 for use by the emitter processor 230 or other higher level applications concerned with pulse processing.

Turning back to FIG. 3, the multi-sensor pilot vector generator 350 is configured to generate pilot vectors based on reception of the pulse at multiple sensors (e.g., antenna arrays), which may have different fields of view. Pilot vectors generated in this manner may then be used on subsequently received pulses. In some embodiments, the pulse direction calculator is configured to calculate a first direction of arrival 405a of the pulse, as previously described, and a second direction of arrival 405b of the pulse. The second direction of arrival 405b of the pulse is based on reception of the pulse through a second antenna array (e.g., 130c). The second direction of arrival calculation is based on pulse phase measurement differences between elements of the second antenna array. The multi-sensor pilot vector generator 350 may then calculate a new pilot vector 360 based on a conic intersection (or possibly two points of intersection) between the first direction of arrival 405a and the second direction of arrival 405b.

The process may be extended to an intersection of any number of additional directions of arrival cones obtained through additional antenna arrays. The intersection of cones may be determined by linear algebraic manipulations in the case of two linear arrays, and/or by minimizing a mutual distance cost function (e.g., least-squares fitting), or through any other suitable geometric techniques.

In some embodiments, the multi-sensor pilot vector generator 350 may be configured to use any suitable interferometric techniques to combine two or more of the antenna arrays to generate an improved angle of arrival estimate for the generation of the multi-sensor pilot vector 360.

FIG. 5 illustrates a pulse direction of arrival as a conic angle 500 along with pilot vectors 510, 520, and 530, in accordance with certain embodiments of the present disclosure. As previously described, a linear antenna array (e.g., 130a) provides an estimated direction of arrival, or line of sight 550, to the emitter 110a. The estimated direction is ambiguous, however, due to the geometry of the linear array which can only provide an angle 500 relative to the axis of the array 540. Other antenna array configuration (e.g., 2-dimensional or 3-dimensional) can reduce such ambiguity, but other sources of error (e.g., measurement error) remain. In any case, the resulting angle 500, or equivalently the line of sight estimate 550, may be used as a basis of comparison to the provided pilot vectors to facilitate the matching of pulses to pilot vectors and the emitters associated with those pilot vectors.

Although the pulse clustering system 220 is shown in the above examples as a separate module, in some embodiments, some or all of the functions of the pulse clustering system 220 may be performed by the receivers. For example, these functions may be performed by execution of firmware by a processor within the receiver, when this capability is available in the receiver.

### Methodology

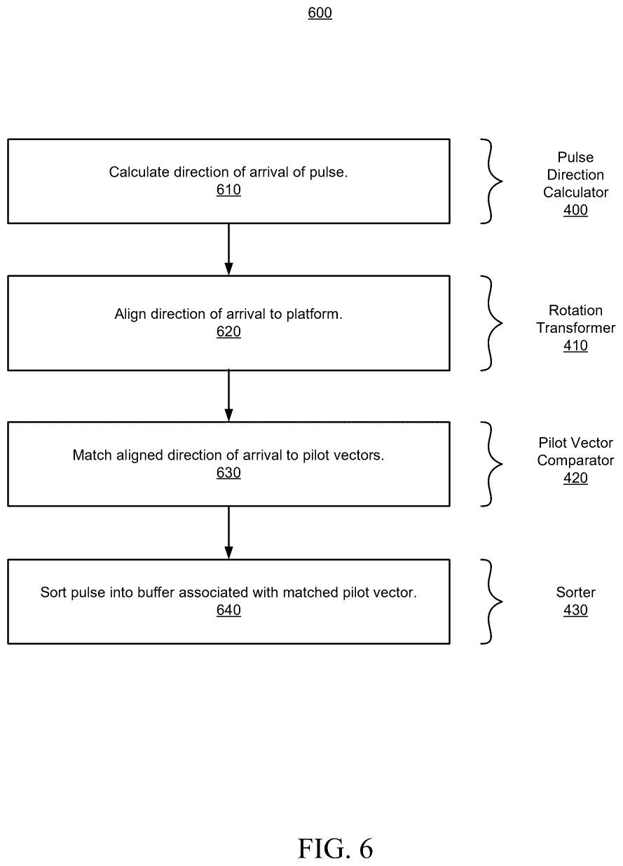

FIG. 6 is a flowchart illustrating a methodology 600 for multi-sensor pulse clustering, in accordance with an embodiment of the present disclosure. As can be seen, example method 600 includes a number of phases and sub-processes, the sequence of which may vary from one embodiment to another. However, when considered in aggregate, these phases and sub-processes form a process for operation of the pulse clustering system 220, in accordance with certain of the embodiments disclosed herein, for example as illustrated in FIGS. 1-5, as described above. However, other system architectures can be used in other embodiments, as will be apparent in light of this disclosure. To this end, the correlation of the various functions shown in FIG. 6 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 600 commences, at operation 610, by calculating a direction of arrival of a pulse received through an antenna array, also referred to as an aperture. The direction of arrival calculation is based on pulse phase measurement differences between elements of the antenna array.

In some embodiments, the antenna array is a linear array, and the direction of arrival is a conic angle between an axis of the linear array and a line of sight to an emitter of the pulse. In some other embodiments, the antenna array is a 2-dimensional planar array or a 3-dimensional array, and the direction of arrival is a line of sight angle to the emitter.

At operation 620, the direction of arrival is aligned to platform body or navigational coordinates.

At operation 630, the aligned direction of arrival is matched to one or more pilot vectors, the pilot vectors indicating directions of interest.

In some embodiments, the pilot vectors are obtained from an emitter tracking system. In some embodiments, the pilot vectors are provided by an operator of the platform (e.g., the pilot of the aircraft).

In some embodiments, a second direction of arrival is calculated for the pulse received through a second antenna array. The second direction of arrival calculation is based on pulse phase measurement differences between elements of the second antenna array. The pilot vector may then be generated based on a conic intersection of the first direction of arrival and the second direction of arrival. The pilot vector generated in this manner may be stored and used for clustering of subsequently received pulses.

At operation 640, the pulse is sorted into a buffer associated with the matched pilot vector.

In some embodiments, additional operations may be performed, as previously described in connection with the system. For example, a rotational coordinate transformation may be performed to update the pilot vectors to a current time of flight based on information provided by the navigation system of the platform. In some embodiments, the pilot vectors are provided in Earth coordinates and the aligned direction of arrival is transformed to Earth coordinates prior to matching to the pilot vectors.

### Example System

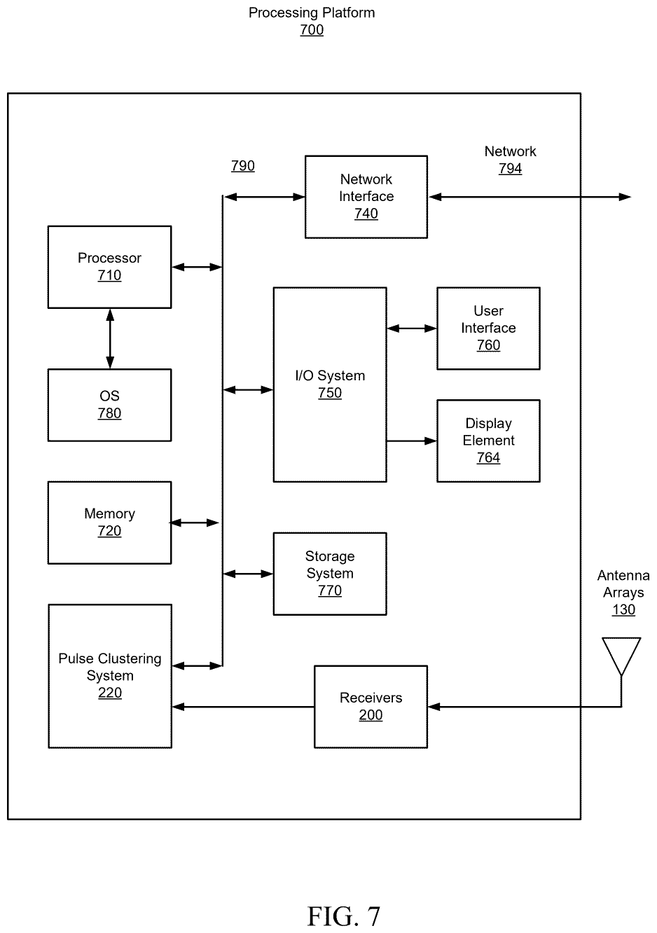

FIG. 7 is a block diagram of a processing platform 700 configured to perform multi-sensor pulse clustering, in accordance with an embodiment of the present disclosure. In some embodiments, platform 700, or portions thereof, may be hosted on, or otherwise be incorporated into the electronic systems of an aircraft.

In some embodiments, platform 700 may comprise any combination of a processor 710, memory 720, a network interface 740, an input/output (I/O) system 750, a user interface 760, a display element 764, a storage system 770, pulse clustering system 220, receivers 200 and antenna arrays 130. As can be further seen, a bus and/or interconnect 790 is also provided to allow for communication between the various components listed above and/or other components not shown. Platform 700 can be coupled to a network 794 through network interface 740 to allow for communications with other computing devices, platforms, devices to be controlled, or other resources. Other componentry and functionality not reflected in the block diagram of FIG. 7 will be apparent in light of this disclosure, and it will be appreciated that other embodiments are not limited to any particular hardware configuration.

Processor 710 can be any suitable processor, and may include one or more coprocessors or controllers, such as an audio processor, a graphics processing unit, or hardware accelerator, to assist in the execution of mission software and/or any control and processing operations associated with platform 700, including operation of the pulse clustering system 220. In some embodiments, the processor 710 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 710 may be implemented as a complex instruction set computer (CISC) or a reduced instruction set computer (RISC) processor. In some embodiments, processor 710 may be configured as an x86 instruction set compatible processor.

Memory 720 can be implemented using any suitable type of digital storage including, for example, flash memory and/or random access memory (RAM). In some embodiments, the memory 720 may include various layers of memory hierarchy and/or memory caches as are known to those of skill in the art. Memory 720 may be implemented as a volatile memory device such as, but not limited to, a RAM, dynamic RAM (DRAM), or static RAM (SRAM) device. Storage system 770 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 710 may be configured to execute an Operating System (OS) 780 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 700, and therefore may also be implemented using any suitable existing or subsequently-developed platform.

Network interface circuit 740 can be any appropriate network chip or chipset which allows for wired and/or wireless connection between other components of platform 700 and/or network 794, thereby enabling platform 700 to communicate with other local and/or remote computing systems, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 750 may be configured to interface between various I/O devices and other components of platform 700. I/O devices may include, but not be limited to, user interface 760 and display element 764. User interface 760 may include devices (not shown) such as a touchpad, cockpit display unit, keyboard, and mouse, etc., for example, to allow the user to control the system. Display element 764 may be configured to display information to a user. I/O system 750 may include a graphics subsystem configured to perform processing of images for rendering on the display element 764. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 710 or any chipset of platform 700.

It will be appreciated that in some embodiments, the various components of platform 700 may be combined or integrated in a system-on-a-chip (SoC) architecture. In some embodiments, the components may be hardware components, firmware components, software components or any suitable combination of hardware, firmware, or software.

Pulse clustering system 220 is configured to perform clustering of emitter generated pulses received from antenna arrays, as described previously. Pulse clustering system 220 may include any or all of the circuits/components illustrated in FIGS. 1-5, as described above. These components can be implemented or otherwise used in conjunction with a variety of suitable software and/or hardware that is coupled to or that otherwise forms a part of platform 700. These components can additionally or alternatively be implemented or otherwise used in conjunction with user I/O devices that are capable of providing information to, and receiving information and commands from, a user.

In various embodiments, platform 700 may be implemented as a wireless system, a wired system, or a combination of both. When implemented as a wireless system, platform 700 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 700 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 794. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 700 may comprise additional, fewer, or alternative subcomponents as compared to those included in the example embodiment of FIG. 7.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a pulse clustering system, the system comprising: a pulse direction calculator configured to calculate a direction of arrival of a pulse received through an antenna array, the direction of arrival calculation based on pulse phase measurement differences between elements of the antenna array; a rotation transformer configured to align the direction of arrival to platform body coordinates; and a pilot vector comparator configured to match the aligned direction of arrival to one or more pilot vectors, the pilot vectors indicating directions of interest.

Example 2 includes the system of Example 1, wherein the antenna array is a linear array, and the direction of arrival is a conic angle between an axis of the linear array and a line of sight to an emitter of the pulse.

Example 3 includes the system of Example 2, wherein the antenna array is a first antenna array, the direction of arrival is a first direction of arrival, and the pulse direction calculator is configured to calculate a second direction of arrival of the pulse received through a second antenna array, the second direction of arrival calculation based on pulse phase measurement differences between elements of the second antenna array.

Example 4 includes the system of Example 3, comprising a multi-sensor pilot vector generator configured to generate the pilot vector based on a conic intersection of the first direction of arrival and the second direction of arrival.

Example 5 includes the system of any of Examples 1-4, wherein the pilot vectors are obtained from an emitter tracking system or from an operator of the platform.

Example 6 includes the system of any of Examples 1-5, comprising a sorting circuit configured to sort the pulse into a buffer associated with the matched pilot vector.

Example 7 includes the system of any of Examples 1-6, comprising a pilot vector time updater configured to perform a rotational coordinate transformation to update the pilot vectors to a current time of flight based on information provided by a navigation system of the platform.

Example 8 includes the system of any of Examples 1-7, wherein the pilot vectors are provided in Earth coordinates and the rotation transformer is configured to transform the aligned direction of arrival to Earth coordinates.

Example 9 is a computer program product including one or more non-transitory machine-readable mediums encoded with instructions that when executed by one or more processors cause a process to be carried out for pulse clustering, the process comprising: calculating a direction of arrival of a pulse received through an antenna array, the direction of arrival calculation based on pulse phase measurement differences between elements of the antenna array; aligning the direction of arrival to platform body coordinates; and matching the aligned direction of arrival to one or more pilot vectors, the pilot vectors indicating directions of interest.

Example 10 includes the computer program product of Example 9,wherein the antenna array is a linear array, and the direction of arrival is a conic angle between an axis of the linear array and a line of sight to an emitter of the pulse.

Example 11 includes the computer program product of Example 10,wherein the antenna array is a first antenna array, the direction of arrival is a first direction of arrival, and the process comprises receiving the pulse through a second antenna array, calculating a second direction of arrival based on pulse phase measurement differences between elements of the second antenna array, and generating the pilot vector based on a conic intersection of the first direction of arrival and the second direction of arrival.

Example 12 includes the computer program product of any of Examples 9-11, wherein the pilot vectors are obtained from an emitter tracking system or from an operator of the platform.

Example 13 includes the computer program product of any of Examples 9-12, wherein the process comprises performing a rotational coordinate transformation to update the pilot vectors to a current time of flight based on information provided by a navigation system of the platform.

Example 14 includes the computer program product of any of Examples 9-13, wherein the pilot vectors are provided in Earth coordinates and the process comprises transforming the aligned direction of arrival to Earth coordinates.

Example 15 is a method for pulse clustering, the method comprising: calculating a direction of arrival of a pulse received through an antenna array, the direction of arrival calculation based on pulse phase measurement differences between elements of the antenna array; aligning the direction of arrival to platform body coordinates; and matching the aligned direction of arrival to one or more pilot vectors, the pilot vectors indicating directions of interest.

Example 16 includes the method of Example 15, wherein the antenna array is a linear array, and the direction of arrival is a conic angle between an axis of the linear array and a line of sight to an emitter of the pulse.

Example 17 includes the method of Example 16, wherein the antenna array is a first antenna array, the direction of arrival is a first direction of arrival, and the method comprises receiving the pulse through a second antenna array, calculating a second direction of arrival based on pulse phase measurement differences between elements of the second antenna array, and generating the pilot vector based on a conic intersection of the first direction of arrival and the second direction of arrival.

Example 18 includes the method of any of Examples 15-17, wherein the pilot vectors are obtained from an emitter tracking system or from an operator of the platform.

Example 19 includes the method of any of Examples 15-18, comprising performing a rotational coordinate transformation to update the pilot vectors to a current time of flight based on information provided by a navigation system of the platform.

Example 20 includes the method of any of Examples 15-19, wherein the pilot vectors are provided in Earth coordinates and the method comprises transforming the aligned direction of arrival to Earth coordinates.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A pulse clustering system, the system comprising:
a pulse direction calculator configured to calculate a direction of arrival of a pulse received through an antenna array, the direction of arrival calculation based on pulse phase measurement differences between elements of the antenna array;
a rotation transformer configured to align the direction of arrival to platform body coordinates; and
a pilot vector comparator configured to match the aligned direction of arrival to one or more pilot vectors, the pilot vectors indicating directions of interest.

2. The system of claim 1, wherein the antenna array is a linear array, and the direction of arrival is a conic angle between an axis of the linear array and a line of sight to an emitter of the pulse.

3. The system of claim 2, wherein the antenna array is a first antenna array, the direction of arrival is a first direction of arrival, and the pulse direction calculator is configured to calculate a second direction of arrival of the pulse received through a second antenna array, the second direction of arrival calculation based on pulse phase measurement differences between elements of the second antenna array.

4. The system of claim 3, comprising a multi-sensor pilot vector generator configured to generate the pilot vector based on a conic intersection of the first direction of arrival and the second direction of arrival.

5. The system of claim 1, wherein the pilot vectors are obtained from an emitter tracking system or from an operator of the platform.

6. The system of claim 1, comprising a sorting circuit configured to sort the pulse into a buffer associated with the matched pilot vector.

7. The system of claim 1, comprising a pilot vector time updater configured to perform a rotational coordinate transformation to update the pilot vectors to a current time of flight based on information provided by a navigation system of the platform.

8. The system of claim 1, wherein the pilot vectors are provided in Earth coordinates and the rotation transformer is configured to transform the aligned direction of arrival to Earth coordinates.

9. A computer program product including one or more non-transitory machine-readable mediums encoded with instructions that when executed by one or more processors cause a process to be carried out for pulse clustering, the process comprising:
calculating a direction of arrival of a pulse received through an antenna array, the direction of arrival calculation based on pulse phase measurement differences between elements of the antenna array;
aligning the direction of arrival to platform body coordinates; and
matching the aligned direction of arrival to one or more pilot vectors, the pilot vectors indicating directions of interest.

10. The computer program product of claim 9, wherein the antenna array is a linear array, and the direction of arrival is a conic angle between an axis of the linear array and a line of sight to an emitter of the pulse.

11. The computer program product of claim 10, wherein the antenna array is a first antenna array, the direction of arrival is a first direction of arrival, and the process comprises receiving the pulse through a second antenna array, calculating a second direction of arrival based on pulse phase measurement differences between elements of the second antenna array, and generating the pilot vector based on a conic intersection of the first direction of arrival and the second direction of arrival.

12. The computer program product of claim 9, wherein the pilot vectors are obtained from an emitter tracking system or from an operator of the platform.

13. The computer program product of claim 9, wherein the process comprises performing a rotational coordinate transformation to update the pilot vectors to a current time of flight based on information provided by a navigation system of the platform.

14. The computer program product of claim 9, wherein the pilot vectors are provided in Earth coordinates and the process comprises transforming the aligned direction of arrival to Earth coordinates.

15. A method for pulse clustering, the method comprising:
calculating a direction of arrival of a pulse received through an antenna array, the direction of arrival calculation based on pulse phase measurement differences between elements of the antenna array;
aligning the direction of arrival to platform body coordinates; and
matching the aligned direction of arrival to one or more pilot vectors, the pilot vectors indicating directions of interest.

16. The method of claim 15, wherein the antenna array is a linear array, and the direction of arrival is a conic angle between an axis of the linear array and a line of sight to an emitter of the pulse.

17. The method of claim 16, wherein the antenna array is a first antenna array, the direction of arrival is a first direction of arrival, and the method comprises receiving the pulse through a second antenna array, calculating a second direction of arrival based on pulse phase measurement differences between elements of the second antenna array, and generating the pilot vector based on a conic intersection of the first direction of arrival and the second direction of arrival.

18. The method of claim 15, wherein the pilot vectors are obtained from an emitter tracking system or from an operator of the platform.

19. The method of claim 15, comprising performing a rotational coordinate transformation to update the pilot vectors to a current time of flight based on information provided by a navigation system of the platform.

20. The method of claim 15, wherein the pilot vectors are provided in Earth coordinates and the method comprises transforming the aligned direction of arrival to Earth coordinates.
